(19) United States
(12) Patent Application Publication
(10) Pub. No.: US 2001/0048041 A1
(43) Pub. Date: Dec. 6, 2001

(54) Crusher

(75) Inventor: Hiroyoshi Nakazato, Namerikawa-city (JP)

Correspondence Address: MERCHANT & GOULD PC, P.O. BOX 2903, MINNEAPOLIS, MN, 55402-0903, US

(73) Assignee: SHINWA INDUSTRIAL CO., LTD. and FRONTIER CO., LTD

(21) Appl. No.: 09/859,783

(22) Filed: May 16, 2001

(30) Foreign Application Priority Data
May 30, 2000 (JP) 2000-159402

(51) Int. Cl. B02C 7/17

(52) U.S. Cl. 241/65; 241/261.2

(57) ABSTRACT

A supplying inlet is placed at a position where materials to be crushed supplying direction is out of position on the forward direction side of a rotating direction against the rotating center of the rotation wing on the supplying side and

a discharge outlet is placed at a position where a crushed object discharge direction is out of position on the forward direction side of a rotating direction against the rotating center of the rotation wing on the discharge side; and

a casing on supplying side and a casing on discharge side to face each other are fit so as to separate from each other. Thereby retention time in the casing of crushed object is short, heat degeneration is little, and a good product can be obtained; and effect of maintenance and cleaning is increased.

### FIELD OF THE INVENTION

The present invention relates to a crusher to crush agricultural objects, mineral objects, medical supplies, or other materials to be crushed, and more particularly to fine powders supplied to a crushing chamber provided between a pair of rotation wings in the casing.

### BACKGROUND OF THE INVENTION

Conventionally, a crusher which rotates a first rotor and a second rotor in a casing, supplies materials to be crushed to a crushing chamber provided between the first rotor and the second rotor, and fine powders materials to be crushed by friction crush is already known, (Refer to Japanese publication No.H7-4553, Japanese publication No.H7-83840, Japanese Laid open publication No.H11-300224, Japanese Laid open publication No. 2000-61340). This conventional crusher has a configuration such that the first rotor and the second rotor are housed in one casing, and a supplying inlet of the materials to be crushed and a discharge outlet of the crushed or powdered objects are provided in this casing. And after the materials to be crushed supplied to the supplying inlet are absorbed in the casing by air current caused by rotation of the rotor and powdered by friction between the first rotor and the second rotor and powdered objects are discharged from the outlet.

However, there are problems in the conventional crushers. That is, there is a problem that since the crusher absorbs and discharges the crushed objects by only circulation of air caused by rotation of the first rotor and the second rotor, and that the configuration is difficult to discharge the crushed objects, retention time in the casing of the crushed objects is long and hereby heat deformation of the obtained products is easily generated.

Further, since the configuration of the conventional crusher is a configuration in which the first rotor and the second rotor are housed in one casing, the casing is fixed to a rotor. Thereby, maintenance or cleaning internal is troublesome. Furthermore, there is a problem that since the inside of the casing in the conventional crusher is easily worn by frictional contact with the materials to be crushed, maintenance to repair the crusher is necessary; and in a case of wearing, remaking casing itself and changing it are necessary, and this working is complex and it takes long time.

And there is a problem that in a case of changing a distance between the rotors according to a kind of materials to be crushed or grading of the crushed object, the crusher having a configuration of Japanese Laid Open publication No.2000-61340 has to be disassembled by unlatching the bolt of a casing body and this working is very troublesome, it takes time long; and distance cannot be easily changed.

### SUMMARY OF THE INVENTION

This invention has been made to solve the above problems, and it is therefore a first object of the invention to provide a crusher in which, by improving a supplying inlet and a discharge outlet, materials to be crushed is smoothly supplied and a crushed object is smoothly discharged; retention time in casing of crushed object is shortened; heat deformation is little; and the crushed object with desired grading is obtained.

A second object of the present invention is to provide a crusher, in which countermeasure against wearing of the casing can be taken; distance between rotation wings cannot be changed easily; and further working effect of maintenance and cleaning is increased by being easily capable of separating a casing on the supplying side and a casing on the discharge side in a short time.

Another object of the present invention is to provide a crusher for introducing materials to be crushed from a supplying inlet into a crushing chamber formed between a rotation wing on the supplying side and a rotation wing on the discharge side to be set to a rotating shaft, and to rotate to face each other in a casing on the supplying side and a casing on the discharge side; and for discharging a crushed object crushed by mutual friction of materials to be crushed from a discharge outlet, in which

the supplying inlet is placed at a position where the materials to be crushed supplying direction is out of position on the forward direction side of the rotating direction against the rotating center of the rotation wing on the supplying side; and

the discharge outlet is placed at a position where the crushed object discharge direction is out of position on the forward direction side of the rotating direction against the rotating center of the rotation wing on the discharge side.

By such configuration, once the materials to be crushed is supplied from the supplying inlet, after the materials to be crushed is rolled up along the rotating direction of the rotating shaft immediately; is passed through the rotation wing and is absorbed to the crushing chamber; and is crushed by friction mutually, the fine powdered object can be discharged from the discharge outlet immediately by using the rotating direction of the rotating shaft.

Another object of the present invention is to provide a crusher for introducing materials to be crushed from a supplying inlet into a crushing chamber formed between a rotation wing on the supplying side and a rotation wing on the discharge side to be set to a rotating shaft, and to rotate to face each other in a casing on the supplying side and a casing on the discharge side; and for discharging a crushed object crushed by mutual friction of materials to be crushed from a discharge outlet, in which

the casing on the supplying side in which the rotation wing on the supplying side is incorporated; and

the casing on the discharge side in which the rotation wing on the discharge side is incorporated are detachably fit at the position of the crushing chamber. By such configuration, changing both casings when being worn in a state where both casings are detached is available and changing interval of both rotation wings is easily available, and further maintenance or cleaning the inside of the casing is available.

Another object of the present invention is to provide a crusher, in which a movement means to move straightly via a movement guide is provided such that the casing on the supplying side and the casing on the discharge side are fit to and are detached from each other. By such configuration, once one of casing on the supplying side or casing on the discharge side is moved back by the movement means, the fit portion of both is unlatched and crush working becomes available by fitting the casing on the supplying side and the casing on the discharge side by the movement means.

Another object of the present invention is to provide a crusher, in which a circular intermediate casing is detachably fit between the casing on the supplying side and the casing on the discharge side. By such configuration, interval of both rotation wings can be easily adjusted.

Another object of the present invention is to provide a crusher, in which spacer rings are detachably fit either or both between the intermediate casing and the casing on the supplying side, or/and between the intermediate casing and the casing on the discharge side. By such configuration, the spacer ring can be easily changed when adjusting interval dimension of both rotation wings by changing thickness of the spacer ring.

Another object of the present invention is to provide a crusher, in which the inner circumference of the spacer ring is arranged at a position so as to face the outer circumference of the rotation wing on the supplying side in the casing on the supplying side or the rotation wing on the discharge side in the casing on the discharge side. By such configuration, material or hardness of the spacer ring can be easily changed according to the materials to be crushed. And material or hardness of the spacer ring can be easily changed at the time of wearing of spacer-ring.

Another object of the present invention is to provide a crusher, in which a jacket for cooling is provided on the outside of the casing on the discharge side, the casing on the supplying side, and the crushing chamber. By such configuration, the casing on the supplying side, the casing on the discharge side and the crushing chamber can be cooled by introducing cooling medium such as cooling liquid or cooling gas into the jacket.

Another object of the present invention is to provide a crusher, in which spacer collars are provided at the rotating shaft; and the rotation wing on the supplying side and the rotation wing on the discharge side set to the rotating shaft are respectively contacted/attached to one end of the spacer collars. By such configuration, a gap between the rotation wing and the casing can be easily changed by moving the position of the rotation wing, which contacts/attaches to this when length of the spacer collar is changed. Therefore, gaps (G1, G2) can be easily changed without changing dimension of the outer diameter f or both rotation wings.

Another object of the present invention is to provide a crusher, in which a lock means, which is capable of fixing at a position where the casing on the supplying side or/and the casing on the discharge side is/are moved along the movement guide is included. By such configuration, the casing on the supplying side or the casing on the discharge side moved through the movement guide by the movement means can be certainly fixed at a predetermined position by the lock means. And a crusher can easily detach and fit a portion in a short time without use of a tool when disassembling both casings.

The above and other objects, features, and advantages of the invention will become more apparent from the following description when taken in conjunction will the accompanying drawings.

### BRIEF DESCRIPTION OF THE DRAWINGS

FIG. 1A shows the state of fitting casing in a side view showing one embodiment according to the present invention.

FIG. 1B shows the state of separating casing.

FIG. 2 is a vertical side view showing disassembly of main portion in FIG. 1.

FIG. 3 is the enlarged sectional view of main portion in FIG. 2.

FIG. 4 is the enlarged sectional view to fit casing according to the present invention.

FIG. 5 is the plan view of a crusher according to the present invention.

FIG. 6 A is a A-A line sectional view in FIG. 4

FIG. 6 B is a B-B line sectional view in FIG. 4.

FIG. 7 is the front view of rotation wing on the supplying side of crusher according to the present invention.

FIG. 8 is the front view of spacer-ring of crusher according to the present invention.

FIGS. 9A, 9B, and 9C are front views showing operating state of lock means in crusher according to the present invention.

### DESCRIPTION OF THE PREFERRED EMBODIMENT

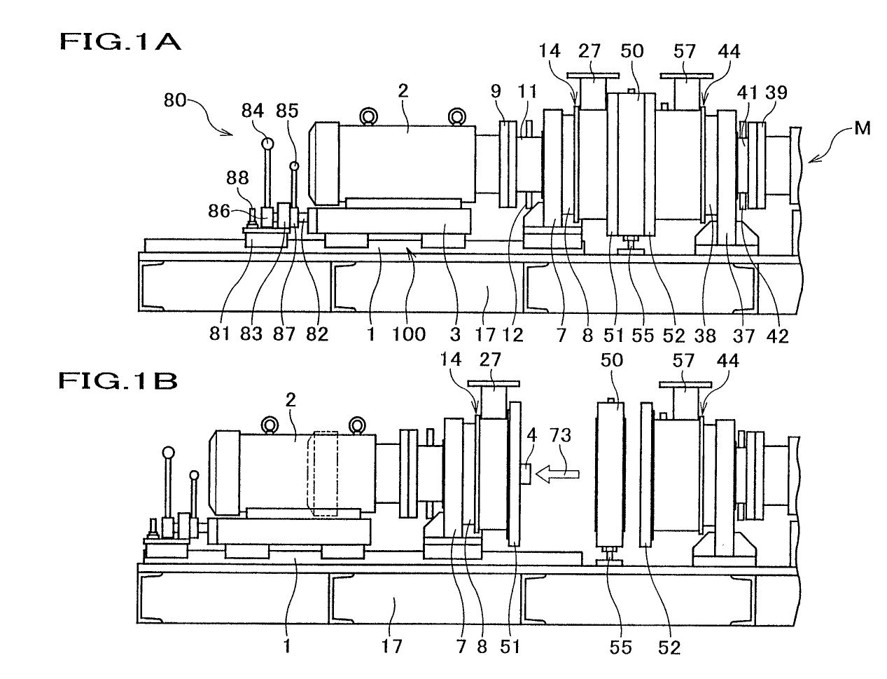

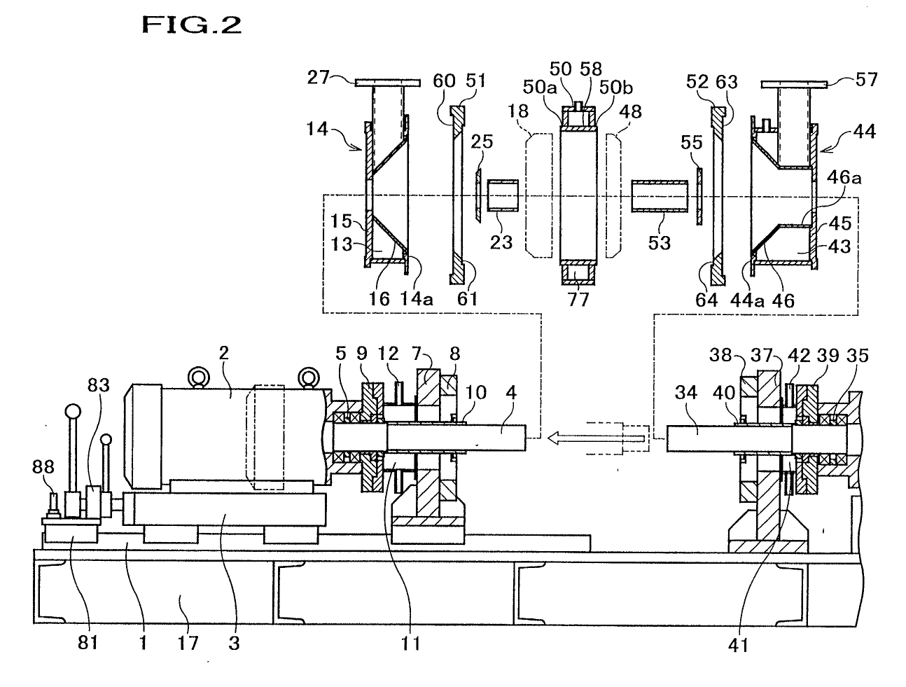

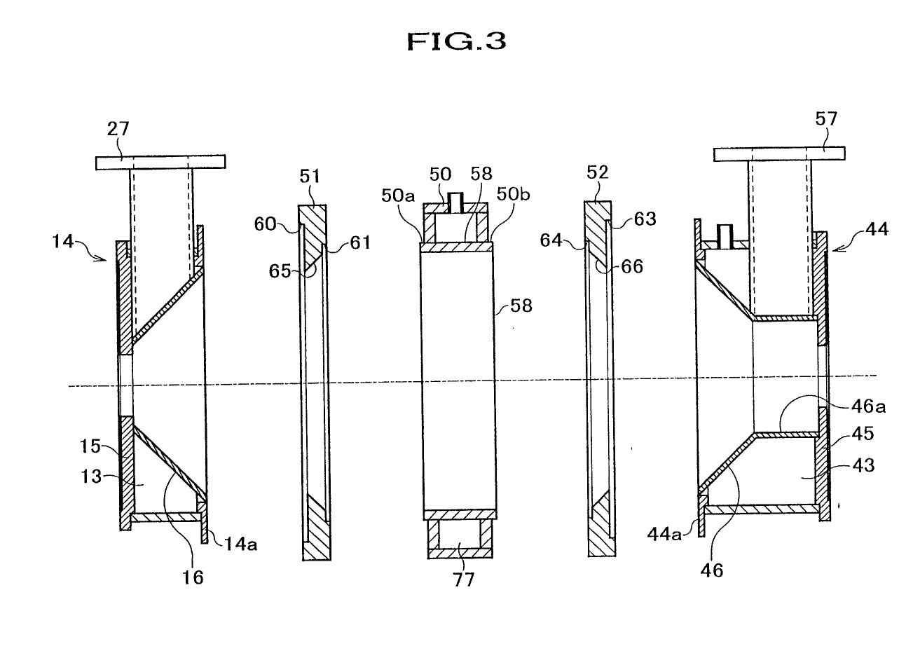

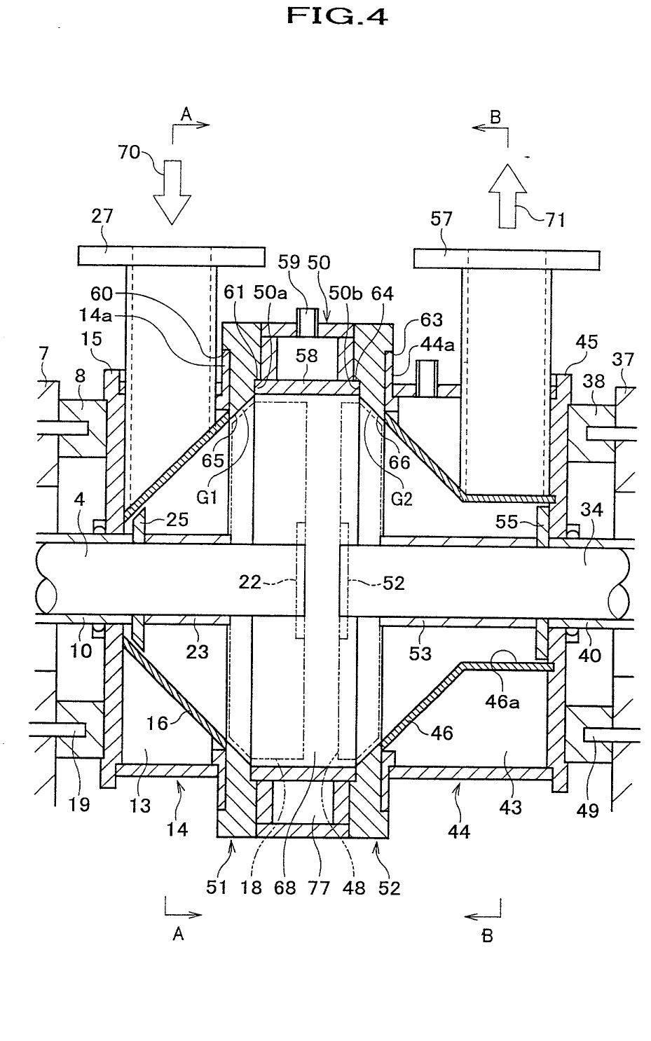

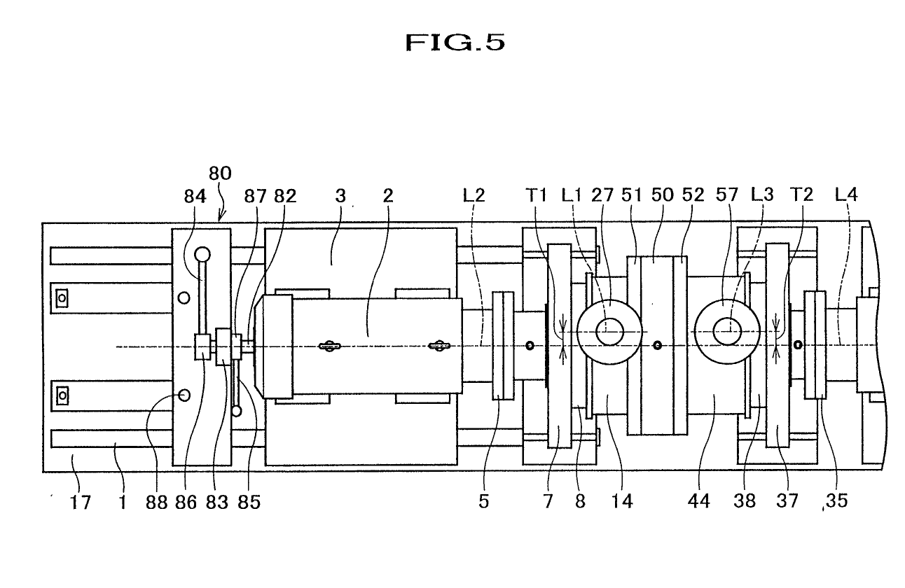

Below, the embodiment of a crusher according to the present invention ref erring to the drawings in detail. FIG. 1A is the state of fitting casing in a side view showing the embodiment of a crusher, and FIG. 1B is the state of separating casing. FIG. 2 is a vertical side view showing disassembly of a main portion. FIG. 3 is the enlarged sectional view of the main portion in FIG. 2. FIG. 4 is the enlarged sectional view in a state fitting casing. FIG. 5 is the plan view of a crusher.

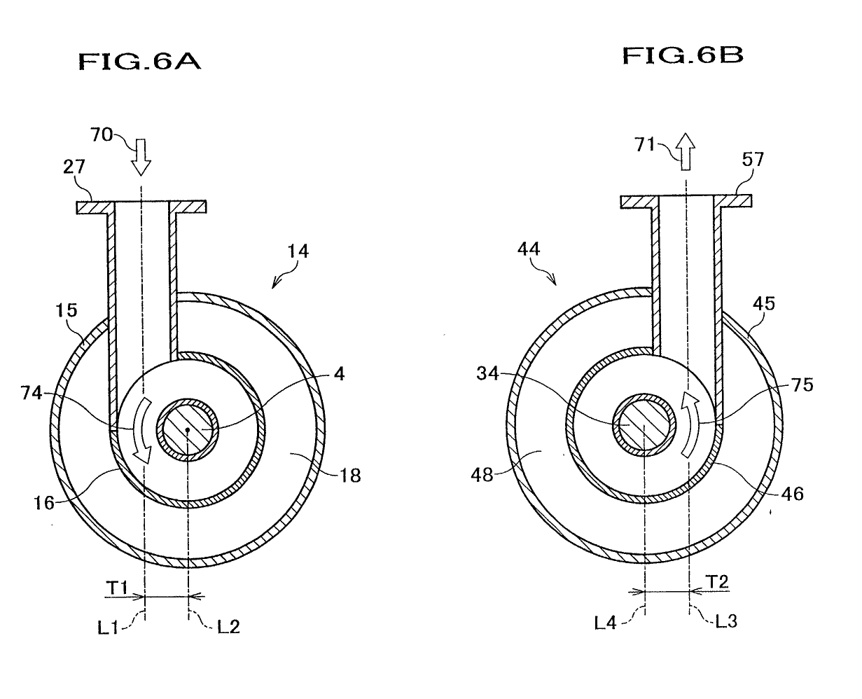

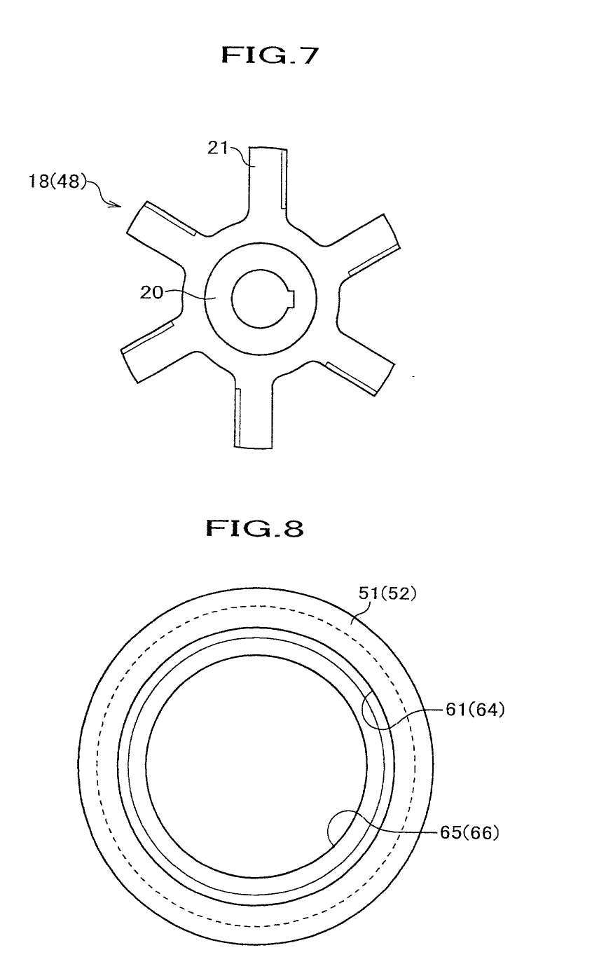

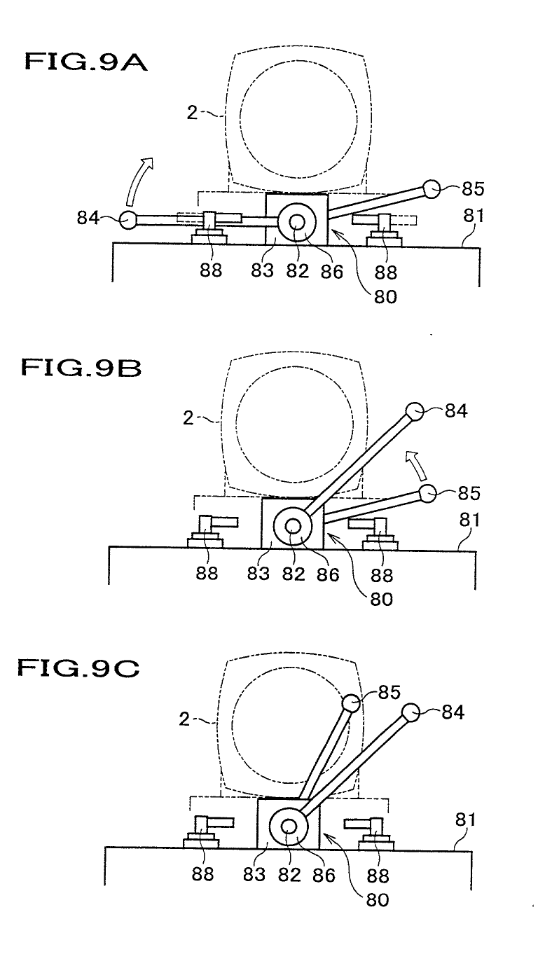

FIG. 6 A is a A-A line sectional view in FIG. 4. FIG. 6 B Is a B-B line sectional view in FIG. 4. FIG. 7 is the front view of a rotation wing on the supplying side. FIG. 8 is the front view of a spacer-ring. FIGS. 9A, 9B, and 9C are front views showing state for operating a lock means.

A crusher M in the present Embodiment as shown in FIGS. 1A, 1B and 4 is almost configured by a casing on supplying side 14, a casing on discharge side 44, a rotation wing on supplying side 18 set to a rotating shaft 4,

a rotation wing on discharge side 48 set to a rotating shaft 44, an intermediate casing 50 and spacer-rings 51, 52 fit between a casing on supplying side 14 and a casing discharge side 44, a movement means 100 to move the casing on supplying side 14 and the casing on discharge side 44, and lock means 80 which capable of fixing movement means 100 at a position.

Movement means 100 has rail-shaped movement guide 1 mounted on basement 17 as shown in FIGS. 1A and 1B and mount 3 of motor 2 is movably mounted on this movement guide 1. Further, lock means 80 provided at the rear of mount 3 of motor 2. And rotating shaft 4 of motor 2 is supported in shaft bearing 5 as shown in FIG. 2 and rotation wing on supplying side 18 is set to the end portion of rotating shaft 4. Spacer collar 23 and collar 10 is mounted on the outer circumference of rotating shaft 4. Also air chamber 11 is provided at the front portion of junction flange 9 and support bodies 7 and 8 movably supported to movement guide 1 are provided at the front portion of air chamber 11.

Shaft bearing 5 is protected from dust with air flushing by introducing air into air chamber 11 from supply port 12. Casing on supplying side 14 is set and fixed to the outside of collar 10 via outer case 15 in the front portion of support body 8 as shown in FIG. 4. Configuration of casing on supplying side 14 is a configuration in which conical shaped inner case 16 is provided in the inside of outer case 15 formed in cylindrical shape. Jacket 13 is formed between inner case 16 and outer case 15. And casing on supplying side 14 is cooled off by introducing cooling medium such as cooling liquid or cooling gas into this jacket 13.

Rotation wing on supplying side 18 fixed at the tip of rotating shaft 4 is set to the front of inner case 16 as shown in FIG. 4. Rotation wing on supplying side 18 has a configuration in which radial wing portion 21 is formed on the outer circumference of a boss portion fixed to rotating shaft 4 as shown in FIGS. 7 and 4. And boss portion 20 is fit into rotating shaft 4, it is tightened from a front portion by tightening nut 22 and the rear portion of boss portion 20 is fixed so as to press the rear portion of boss portion 20 against spacer collar 23. Seal board 25 is held between spacer collar 23 and collar 10.

Further, supplying inlet 27 is provided at the front of outer case 15 as shown in FIGS. 4 and 6A.

The lower portion of supplying inlet 27 is connected to the upper portion of inner case 16. Supplying inlet 27 is provided such that center line L1 is out of position, for dimension T1, against rotating center L2 of rotating shaft 4. And a direction to be out of position is a direction where supplying direction of materials to be crushed 70 is the forward direction side of rotating direction 74 of rotation wing on supplying side 18. That is, the state is that center line L1 of supplying inlet 27 and rotating center L2 of rotating shaft 4 are not crossed.

In FIGS. 1A, 1B and 4, casing on discharge side 44 is set to rotating shaft 34 so as to mutually face to the casing on supplying side 14. Spacer collar 23 and collar 40 are mounted on the outer circumference of rotating shaft 34. Air chamber 41 is provided at the front of junction flange 39 and support bodies 37, 38 fixed to mount 17 are provided at the front portion in air chamber 41. And shaft bearing 5 is protected from dust with air flushing by introducing air into air chamber 41 from supply port 42.

Casing on discharge side 44 is set and fixed to the outer circumference of collar 40 via outer case 15 and in the front portion of support body 8. As shown in FIGS. 3 and 4, the configuration of casing on discharge side 44 is a configuration in which conical shaped inner case 46 is provided in the inside of outer case 15 formed in cylindrical shape and cylindrical guide 46a in cylindrical shape is provided at the tip of inner case 46. And jacket 43 is formed between inner case 46 and an outer case. Further casing on discharge side 44 is cooled off by introducing cooling medium such as cooling liquid or cooling gas into this jacket 43.

Rotation wing on discharge side 48 fixed at the tip of rotating shaft 34 is set to the front of inner case 46 as shown in FIG. 4. The configuration of this rotation wing on discharge side 48 is almost the same configuration as rotation wing on supplying side 18 shown in FIG. 7. And rotation wing on discharge side 48 is tightened from a front portion by tightening nut 52, the rear portion of boss portion 20 (Refer to FIG. 7) is fixed so as to press against spacer collar 53. Seal board 55 is held between this spacer collar 53 and collar 40.

Discharge outlet 57 is provided at the front portion of outer case 45 as shown in FIGS. 4 to 6B. The lower portion of this discharge outlet 57 is connected to the upper portion of cylindrical guide 46a. This discharge outlet 57 is provided such that center line L3 is out of position, for dimension T2, against rotating center L4 of rotating shaft 34 as shown in FIG. 6B. And a direction to be out of position is a direction where the discharge side of non-crushed object 71 is the forward direction side of rotating direction 75 of rotation wing on discharge side 48. That is, center line L3 of discharge outlet 57 and rotating center L4 of rotating shaft 34 are not crossed.

Note that an example in FIGS. 6A and 6A shows cases of rotating rotation wing on supplying side 18 and rotation wing on discharge side 48 in a reverse direction in a state to face rotation wing on supplying side 18 to rotation wing on discharge side 48. In this case, the state of supplying inlet 27 and discharge outlet 57 is that center lines L2, L3 are respectively out of positions, for dimension T1, T2, against rotating centers L2, L4. In contrast, in a case where rotation wing on supplying side 18 and rotation wing on discharge side 48 rotate in the same direction, supplying inlet 27 and discharge outlet 57 are placed such that the supplying direction of materials to be crushed 70 and the discharge direction of crushed object 71 are forward direction along the rotating direction.

On the other hand, intermediate casing 50, and first spacer-ring 51 and second spacer-ring 52 exist between casing on supplying side 14 and casing on discharge side 44 as shown in FIGS. 1A, 1B to 4.

Jacket portion 77 is provided on the outer circumference of cylindrical portion 58 and intermediate casing 50 cools crush chamber 68 by introducing cooling medium such as cooling liquid or cooling gas from introduction inlet 59. This intermediate casing 50 is detachably supported to basement 17 via holder 55 (Refer to FIGS. 1A and 1B).

Concavity portion 60 to fit into inner flange portion 14a in casing on supplying side 14 is formed on the outside of first spacer-ring 51 and first spacer-ring 51 is a ring-shaped spacer ring in which concavity portion 61 to fit to step portion 50a of intermediate casing 50 is formed on the inside (Refer to FIG. 3).

And, concavity portion 63 to fit to inner flange portion 44a of casing on discharge side 44 is formed on the outside of second spacer-ring 52 and second spacer-ring 52 is a ring-shaped spacer ring in which concavity portion 64 to fit to step portion 50b of intermediate casing 50 is formed on the inside (Refer to FIG. 3).

And taper surfaces 65 and 66 are respectively formed on the internal circumferences of first spacer-ring 51 and second spacer-ring 52, and taper surfaces 65 and 66 respectively face to outer surfaces of rotation wing on supplying side 18 and rotation wing on discharge side 48 respectively to have gaps G1 and G2 (Refer to FIG. 4).

Note that gaps G1 and G2 are very narrow and member specially placed at gaps G1 and G2 are easily worn when materials to be crushed or a crushed object is passed.

Lock means 80 to lock mount 3 of motor 2 to basement 17 is provided as shown in FIGS. 1A, 1B, 5, and 9. That is, lock means 80 is placed at the rear of mount 3. And lock means 80 is configured by lock mount 81 slidable to movement guide 1, pin lever 88 provided on this lock mount 81, screw rod 82 fixed to mount 3 via project portion 83, nut for clamp 86 and nut for lock 87 provided at front and rear of screw rod 82 for projecting to front and rear of project portion 83, and clamp lever 84 and lock lever 85 to control this nut for clamp 86 and nut for lock 87.

When lock means 80 is controlled, pin lever 88 of lock mount 81 is rotationally controlled from a position of virtual line to the position of continuous line as shown in FIG. 9A. Lock mount 81 is fixed to basement 17 by inserting pin lever 88 in pin hole (not shown) and locking pin lever 88 to basement 17. Next, clamp lever 84 is rotationally moved in the direction of an arrow as shown in FIG. 9A and a fit portion is strongly clamped by screwing screw rod 82 tightening mount 3 as shown in FIG. 9B.

Further, lock lever 85 is rotationally moved in the direction of an arrow as shown in FIG. 9B and lock lever 85 is strongly locked as shown in FIG. 9C not so as to undo screw rod 82. Each fit portion of casing on supplying side 44 and intermediate casing 50, and casing 44 on the discharge side is further strongly tightened and fixed by easily operating clamp lever 84 and lock lever 85 in a short time in this manner.

Next, a function will be described based on the configuration of the crusher M.

FIG. 1A is a state where casing on supplying side 14 and casing on discharge side 44 are fit at a position where casing on supplying side 14 and casing on discharge side 44 are faced each other via intermediate casing 50 and spacer-rings 51, 52. Once motor 2 is driven in this state, rotation wing on supplying side 18 is rotated in a clockwise direction in FIG. 6A (from the motor side) (in the direction of an arrow 74) via rotating shaft 4. Also, once a motor on the opposite side is driven, rotation wing on discharge side 48 is rotated in a clockwise direction in FIG. 6B (from the motor side) (in the direction of an arrow 75) via rotating shaft 34. That is, rotation wing on supplying side 18 and rotation wing on discharge side 48 are mutually rotated in reverse so as to face, and circulation of air is generated in crushing chamber 68 between both rotation wings on supplying side 48.

Once the materials to be crushed is supplied from supplying inlet 27 in this condition as shown in FIG. 4 6A or 6B, the materials to be crushed is dropped like showing arrow 70, is entered in inner case 16, is passed through rotation wing on supplying side 18, and is absorbed in crushing chamber 68.

At this time, since center line L1 of supplying inlet 27 is out of position, for only dimension T1, against rotating center L2 of rotating shaft 4, suction power by rotation of rotation wing on supplying side 18 effectively acts on the materials to be crushed, and thereby suction of the materials to be crushed becomes smooth and the speed to intake the materials to be crushed becomes fast.

After the materials to be crushed introduced into crushing chamber 68 is crushed by friction between each other, the crushed object is passed through conical-shaped inner case 16, and after that it is further passed through cylindrical-shaped cylindrical guide 46a, and a powdered object is discharged from discharge outlet 57 via an absorption pipe (not shown).

Further, discharge becomes easy to rectify powdered object by providing with cylindrical guide 46a, control of absorption becomes easy, and crushed object of desired grading can be gained easily. Further, at this time since center line L3 of discharge outlet 57 is out of position, for only dimension T2, against rotating center L4 of rotating shaft 4,

discharge force by rotating rotation wing on discharge side 48 effectively acts on the crushed object, and thereby discharging the crushed object becomes smooth and the speed to discharge becomes fast.

Note that when crush working, a cooling medium is cycled in jackets 13, 43, and 77, and thereby heat caused by crush working is absorbed on jackets 13, 43, and 77 side and deterioration of the materials to be crushed by heat can be suppressed to a minimum.

When conducting maintenance or cleaning inside of case, maintenance or cleaning is conducted to make casing on supplying side 14 move from a state shown in FIG. 1A to a state shown in FIG. 1B. When making casing on supplying side 14 move, casing on supplying side 14 is moved to operate lock means 80 as shown in FIGS. 9A to 9C.

That is, pin lever 88 is released from condition of FIG. 9C, a lock lever is released so as to be a state from FIG. 9C to FIG. 9B, and then a clamp lever is released so as to be a state from FIG. 9B to FIG. 9A, and thereby fit portions are unlatched. Mount 3 can be moved to the rear along movement guide 1 (state of FIG. 1B). Therefore, motor 2, rotating shaft 4, and support bodies 7, 8 are also moved and

casing on supplying side 14 is moved back in the direction where casing on supplying side 14 is detached from intermediate casing 50 and casing on discharge side 44. Therefore, the fit portions can be detached and disassembled by easy and simple operation in a short time.

Since intermediate casing 50 is fixed by fitting intermediate casing 50 to casing on supplying side 14 and casing on discharge side 44, and by extrusive pressure, it is possible to make intermediate casing 50 easily move. And although it is possible to make casing on supplying side 14 move by releasing lock means 80, casing on supplying side 14 is configured such that casing on supplying side 14 can be moved on movement rail 1 manually in the present embodiment. Of course, this movement means 100 may be configured so as to make movement means 100 move by using driving mechanisms other than manual.

Here, since first spacer-ring 51 and second spacer-ring 52 are not held by casing on supplying side 14, each of first spacer-ring 51 and second spacer-ring 52 becomes a state in which first spacer-ring 51 and second spacer-ring 52 are detached from intermediate casing 50 and can be taken off by hand. Although intermediate casing 50 keeps a state in which intermediate casing 50 is set to holder 55, intermediate casing 50 can be separated if intermediate casing 50 is detached from this holder 55 (whole of holder 55 may detached from basement 17). Further, first spacer-ring 51 and second spacer-ring 52 may be configured so as to bolt stop to casing on supplying side 14 and casing discharge side 44, respectively.

In this way, after casing on supplying side 14, first spacer-ring 51, intermediate casing 50, second spacer-ring 52, and casing on discharge side 44 are separated and maintenance or cleaning is conducted; as opposite to the aforementioned; second spacer-ring 52, intermediate casing 50, and first spacer-ring 51 are respectively fit to casing discharge side 44, second spacer-ring 52, and intermediate casing 50. And once it is to make mount 3 advance, casing on supplying side 14 is fit to first spacer-ring 51, and then a state in FIG. 1A is recovered by locking casing on supplying side 14 with lock means 80.

At this time, since casing on supplying side 14, first spacer-ring 51, intermediate casing 50, second spacer-ring 52 and casing on discharge side 44 are locked by lock means 80 in the state of fitting each other even if there is no fixing means such as a bolt, crush working of the materials to be crushed can be conducted.

In the working mentioned above, first spacer-ring 51 and second spacer-ring 52 can be easily changed to one another. That is, various thickness and materials for first spacer-ring 51 and second spacer-ring 52 are previously prepared in accordance with the materials to be crushed being processed. If first spacer-ring 51 and second spacer-ring 52 with thin thickness (thick) are used, interval of rotation wing on supplying side 18 and rotation wing on discharge side 48 (width of crushing chamber 68) can be wide (thin).

And, in a case where the materials to be crushed is hard, first or second spacer-ring 51, 52 of hard material such as that made of ceramic can be used and in a case where the materials to be crushed is soft, first or second spacer-ring 51, 52 made by usual metal can be used. Further, gaps G1 and G2 are quickly worn since the materials to be crushed or crushed object is passed through gaps G1 and G2. In a case where gaps G1 and G2 are too wide by wearing in this way, a spacer-ring can be easily changed to a new one. Therefore, gaps G1 and G2 can be changed by changing dimension of spacer collars 23 and 53 without changing dimension of the outer diameters of both rotation wings 18 and 48.

As mentioned above, although embodiments of this invention are described in detail, configuration is not limited to the above embodiments and modification of design within the range of this subject matter is included in this invention. For example, supplying inlet 27 and discharge outlet 57 may be placed not at the upper portion, that is, supplying inlet 27 and discharge outlet 57 may be arranged at the position of outer cases 15 and 45, for example, at side portion or lower portion (in a case of discharge outlet 57) if it is configured to be capable of moving the center lines to predetermined directions from the center lines of rotating shafts 4, 34 respectively as shown in FIGS. 6A and 6B. Also dimension to be out of position is not limited if the center lines and the center lines of rotating shafts 4,34 do not overlap respectively, and the materials to be crushed can be supplied smoothly and the crushed object can be discharged smoothly.

A configuraion such that casing on supplying side 14 and casing on discharge side 44 are directly fit is available without using intermediate casing 50 and first spacer-ring 51, the second spacer-ring 52. In that case, project portion is formed at a facing portion outer cases 15 and 45 of casing on supplying side 14 and casing on discharge side 44, and a configuration so as to fit this may be available. Or a configuration to use the only one of first spacer-ring 51, second spacer-ring 52, or intermediate casing 50 or a configuration to combine two or more of them is also available.

Furthermore, casing on discharge side 44 can be configured so as to have a movement means similar to the movement means of casing on supplying side 14. At this time, a lock means is provided on the side where a movement means is provided. Further, crush working can be conducted to change rotating speed for each of rotation wing on supplying side and rotation wing on discharge side.

In the configuration of the crusher M, although one and the other motor are used to drive both rotation wings, motors are configured as a single body and

the crusher M may be configured so as to place both rotation wings at the rotating shaft.

As to the casing on the supplying side and the casing on the discharge side, each of members symmetrically positioned may be configured with the same shaped member.

As described the above in detail, according to the invention of claim 1, since the supplying inlet and the discharge outlet are respectively placed at the position against the rotating center of the rotation wing on the supplying side and the rotation wing on the discharge side, the materials to be crushed supplied to the supplying inlet is immediately absorbed to the crushing chamber and crushed and powdered object is immediately discharged from discharged and powdered object is immediately discharged from the discharged outlet. Therefore, since retention time in the casing of the crushed object is short, heat deformation is little. And object with the desired grading can be obtained and the crusher can be configured with high efficiency.

Further, according to the invention of claim 2, since the casing on the supplying side and the casing on the discharge outlet are separably fit each other, maintenance or cleaning of the inside of the casing in the case separating both casings is available and effect of maintenance and cleaning can be improved.

Further, according to the invention of claim 3, when one of the casing on the supplying side and the casing on the discharge side is moved back, the fit portion is unlatched, and thereby simply detaching or fitting them in a short time is available without use of tools. Therefore, since both casings can be fit via the movement means, working for crushing the materials to be crushed can be conducted in the crushing chamber formed by fitting both casings without a tool such as the bolt.

Further, according to the invention of claim 4, interval between the rotation wing on the supplying side and the rotation wing on the discharge side can be set by existence of the intermediate casing with change of dimension of the intermediate casing without change of the casings on the supplying side and the casing on the discharge side.

Further, according to the invention of claim 5, interval between the rotation wing on the supplying side and the rotation wing on the discharge side can be set by existence of the spacer-rings without change of the casings on the supplying side and the casing on the discharge side.

Further, according to the invention of claim 6, since the inner circumference of the spacer-ring is arranged at a position so as to face

the outer circumference of the rotation wing, it is possible to change the spacer-ring to the new one when the gap between the spacer-ring and the rotation wing becomes wide by wearing and the like.

Further, material and hardness of the spacer-ring can be changed according to materials to be crushed.

Further, according to the invention of claim 7, a product can be prevented from heat deformation caused by cooling both casings etc. by introducing the cooling medium such as cooling gas or cooling liquid into the jacket.

Further, according to an invention of claim 8, since the position for setting the rotation wing, which contacts/attaches to the spacer collars is moved by change of length of the spacer collars, the gap between the rotation wing and the casing can easily be changed. Therefore, the gap between G1 and G2 can easily be changed without change of the outer diameter for the rotation wing.

Further, according to the invention of claim 9, working of easily detaching or fitting the fit portion of the crushing chamber formed by both casings or the intermediate casing can be simply conducted in a short time by combining the movement means for moving the casing on the supplying side (casing on discharge side) with the lock means without use of tools when disassembling the crusher.

What is claimed is:

1. A crusher for introducing materials to be crushed from a supplying inlet into a crushing chamber formed between a rotation wing on the supplying side and a rotation wing on the discharge side to be set to a rotating shaft, and to rotate to face each other in a casing on the supplying side and a casing on the discharge side; and for discharging a crushed object crushed by mutual friction of materials to be crushed from a discharge outlet, wherein
the supplying inlet is placed at a position where the materials to be crushed supplying direction is out of position on the forward direction side of the rotating direction against the rotating center of the rotation wing on the supplying side; and
the discharge outlet is placed at a position where the crushed object discharge direction is out of position on the forward direction side of the rotating direction against the rotating center of the rotation wing on the discharge side.

2. A crusher for introducing materials to be crushed from a supplying inlet into a crushing chamber formed between a rotation wing on the supplying side and a rotation wing on the discharge side to be set to a rotating shaft, and to rotate to face each other in a casing on the supplying side and a casing on the discharge side; and for discharging a crushed object crushed by mutual friction of materials to be crushed from a discharge outlet, wherein
the casing on the supplying side in which the rotation wing on the supplying side is incorporated; and
the casing on the discharge side in which the rotation wing on the discharge side is incorporated are detachably fit at the position of the crushing chamber.

3. A crusher as set forth in claim 1, wherein
a movement means to move straightly via a movement guide is provided such that the casing on the supplying side and the casing on the discharge side are fit to and are detached from each other.

4. A crusher as set forth in claim 2, wherein
a movement means to move straightly via a movement guide is provided such that the casing on the supplying side and the casing on the discharge side are fit to and are detached from each other.

5. A crusher as set forth in claim 1, wherein a circular intermediate casing is detachably fit between the casing on the supplying side and the casing on the discharge side.

6. A crusher as set forth in claim 2, wherein a circular intermediate casing is detachably fit between the casing on the supplying side and the casing on the discharge side.

7. A crusher as set forth in claim 5, wherein spacer rings are detachably fit either or both between the intermediate casing and the casing on the supplying side, or/and between the intermediate casing and the casing on the discharge side.

8. A crusher as set forth in claim 6, wherein spacer rings are detachably fit either or both between the intermediate casing and the casing on the supplying side, or/and between the intermediate casing and the casing on the discharge side.

9. A crusher as set forth in claim 7, wherein the inner circumference of the spacer ring is arranged at a position so as to face the outer circumference of the rotation wing on the supplying side in the casing on the supplying side or the rotation wing on the discharge side in the casing on the discharge side.

10. A crusher as set forth in claim 8, wherein the inner circumference of the spacer ring is arranged at a position so as to face the outer circumference of the rotation wing on the supplying side in the casing on the supplying side or the rotation wing on the discharge side in the casing on the discharge side.

11. A crusher as set forth in claim 1, wherein a jacket for cooling is provided on the outside of the casing on the discharge side, the casing on the supplying side, and the crushing chamber.

12. A crusher as set forth in claim 2, where in a jacket for cooling is provided on the outside of the casing on the discharge side, the casing on the supplying side, and the crushing chamber.

13. A crusher as set forth in claim 1, wherein spacer collars are provided at the rotating shaft; and
the rotation wing on the supplying side and the rotation wing on the discharge side set to the rotating shaft are respectively contacted/attached to one end of the spacer collars.

14. A crusher as set forth in claim 2, wherein spacer collars are provided at the rotating shaft; and
the rotation wing on the supplying side and the rotation wing on the discharge side set to the rotating shaft are respectively contacted/attached to one end of the spacer collars.

15. A crusher as set forth in claim 3, wherein a lock means, which is capable of fixing at a position where the casing on the supplying side or/and the casing on the discharge side is/are moved along the movement guide is included.

16. A crusher as set forth in claim 4, wherein a lock means, which is capable of fixing at a position where the casing on the supplying side or/and the casing on the discharge side is/are moved along the movement guide is included.
